(19) United States
(12) Patent Application Publication
(10) Pub. No.: US 2026/0303647 A1
(43) Pub. Date: Oct. 1, 2026

(54) SYSTEM FOR MANAGING SECURE ASSET REDISTRIBUTION ON A DISTRIBUTED DATA NETWORK

(71) Applicant: Elizabeth BORUHOVIN, McLean, VA (US)

(72) Inventor: Elizabeth BORUHOVIN, McLean, VA (US)

(21) Appl. No.: 19/551,058

(22) Filed: Feb. 26, 2026

Related U.S. Application Data
(63) Continuation-in-part of application No. 17/408,412, filed on Aug. 21, 2021, now abandoned.

(51) Int. Cl. H04L 9/40; H04L 43/0852; H04L 61/5007; H04L 101/69

(52) U.S. Cl. CPC H04L 63/1433; H04L 43/0852; H04L 61/5007; H04L 2101/69

(57) ABSTRACT

The system secures network-based asset redistribution, including re-gifting through a network, using hardware-rooted identifiers as verified device signatures. The system includes a network interface configured to communicate with a plurality of distributed nodes, a hardware processor in communication with the network interface, and a non-transitory memory storing a multidimensional data structure. The system provides network-level security and spoofing avoidance in distributed environments where traditional user-input identifiers are insufficient for high-integrity transactions.

### CROSS-REFERENCE TO RELATED APPLICATIONS

The present application claims priority under 35 U.S.C. Section 120 from U.S. patent application Ser. No. 17/408,412, filed on 21 Aug. 2021, entitled “METHOD AND SYSTEM FOR RECOMMENDING, MONITORING, SELECTING, PURCHASING AND DELIVERING GIFTS”, which claims priority under 35 U.S.C. Section 120 from U.S. patent application Ser. No. 15/323,353, filed on 30 Dec. 2016, entitled “METHOD AND SYSTEM FOR RECOMMENDING, MONITORING, SELECTING, PURCHASING AND DELIVERING GIFTS”, granted as U.S. Pat. No. 11,132,731. See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to distributed data networks and, more particularly, to a system for managing secure asset redistribution and state synchronization across disparate network nodes using hardware-bound identity verification.

### 2. Description of Related Art Including Information Disclosed Under 37 CFR 1.97 and 37 CFR 1.98

Conventional systems for digital asset transfer and data profile management often suffer from high latency and low data integrity due to manual user-input cycles and the lack of hardware-bound verification. In distributed environments, accurately populating user profiles from disparate sources presents a “state synchronization” problem, where data becomes stale or unverified.

Furthermore, traditional methods of verifying transaction intent often rely on high-level application data, which is susceptible to spoofing and session hijacking. There exists a technical need for a system that can dynamically instantiate transaction state machines that are intrinsically linked to lower-layer network metadata, such as Internet Protocol (IP) addresses and geolocation signatures, to ensure the integrity of the asset redistribution path. The present invention addresses these technical hurdles by integrating asynchronous data-fetching protocols with a hardware-bound heuristic filtering architecture.

In the admitted prior art, including U.S. Pat. No. 11,132,731 issued on 28 Sep. 2021 and US Patent Publication No. 20210398092, published on 23 Dec. 2021, the digital asset transfer was disclosed as sending gifts through an app on a mobile phone device. The network interface was the app that communicated on different mobile phone devices as distributed nodes. With such distribution of devices all over wireless networks, the reliable verification was a daunting problem. No longer limited to “IP address”, the hardware-rooted identifier now covers IP addresses, secure enclave keys, Universally Unique Identifiers (UUID)s, and Media Access Control (MAC) addresses. The system is now more reliably ensuring integrity of the asset redistribution or re-gifting through the network.

These and other objectives and advantages of the present invention will become apparent from a reading of the attached specification, drawings and claims.

### BRIEF SUMMARY OF THE INVENTION

The present disclosure addresses the technical problem of network-level asset security and spoofing in distributed environments where traditional user-input identifiers are insufficient for high-integrity transactions. A gift transaction through mobile phones on wireless networks is particularly susceptible. Conventional systems often rely on static database lookups that fail to account for the dynamic, often fraudulent, nature of network-originated requests.

The disclosed system solves this by implementing a hardware-rooted verification architecture. By utilizing a transaction state machine that remains in an “incomplete” state until an asynchronous data-fetch satisfies a multidimensional profile, the system ensures that asset redistribution is not merely a triggered event, but a computationally verified process. Furthermore, by processing hardware-rooted identifiers through a heuristic filter mapped to a contextual preference library, the system algorithmically constrains the available interaction space (the “restricted selection menu”). This technical constraint reduces the attack surface for unauthorized asset requests and ensures that asset re-routing is tethered to verified hardware signatures rather than spoofable software-layer credentials. The automatic population of profiles and the hardware-rooted identifier of the IP protocol address of the present invention are more than filtering menu choices for a selected menu. There is an algorithmic interaction with automated steps and authentication to reduce attacks on fraudulent transactions or gift giving asset transfers.

### BRIEF DESCRIPTION OF THE SEVERAL VIEWS OF THE DRAWINGS

FIG. 1 is a schematic view of a network interface, distributed nodes, hardware processor, and memory of the system of the present invention.

FIG. 2 is a schematic view of an illustration of the overall relationship between the first user node and the second user node according to the present invention.

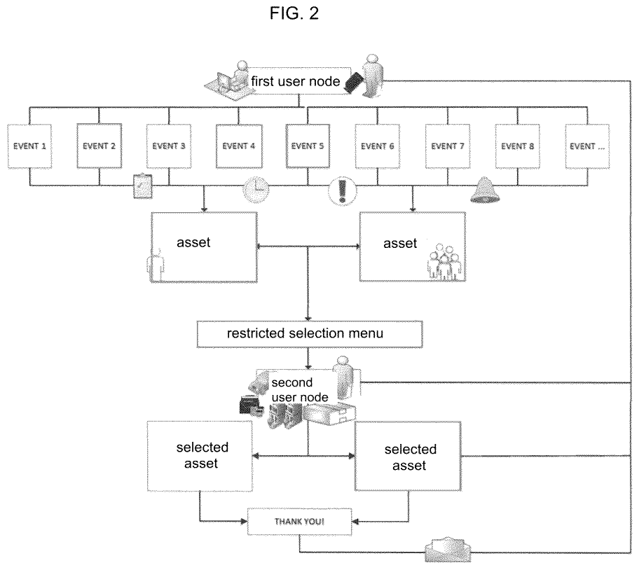

### DETAILED DESCRIPTION OF THE INVENTION

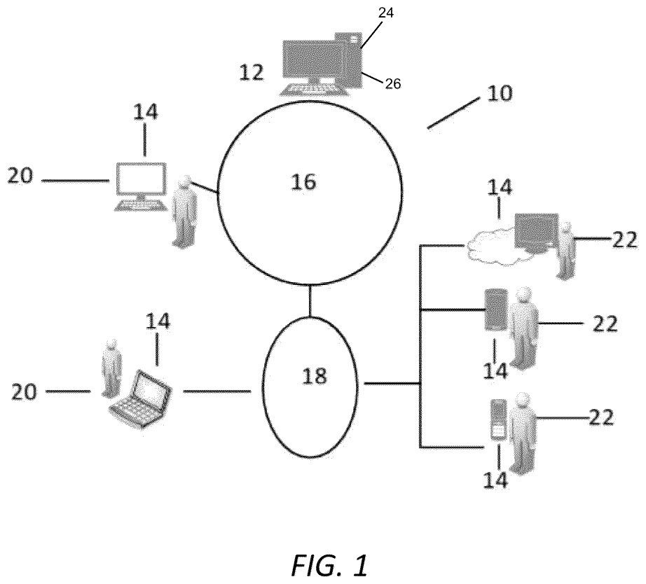

The present invention is a system 10 for secure network-based asset redistribution using verified device signatures. FIG. 1 shows a schematic illustration of an embodiment of the system 10. The system 10 has a hardware processor 12, a network interface 24, and a non-transitory memory 26. Any device as a distributed node 14 is configured to connect to a data network 16 or a wireless network 18. The wireless network 18 connects to the computer network 16, and each device 14 has a corresponding profile. The present invention may include a computer network 16 or a mobile communications network or other data networks. FIG. 1 shows the distributed nodes 14 as computer terminals 20 and as smartphones 22, a type of smart device. Gaming devices could also be distributed nodes 14 in the system 10. The hardware processor 12 has a network interface 24 and a memory storage 26. The computer terminals 20 and smartphones 22 and other devices can be the user interface.

The system 10 secures network-based asset redistribution using verified device signatures. The network-based asset can be a gift, and the redistribution is the re-gifting. The verified device signatures are part of the primary data profile of each distributed node 14., The system 10 includes a network interface 24 configured to communicate with a plurality of distributed nodes 14, and there is a hardware processor 12 in communication with the network interface 24. The non-transitory memory 26 stores a multidimensional data structure, including a transaction profile, target profile, and target sub-profiles.

The memory 26 further stores instructions that, when executed by the hardware processor, cause the system to instantiate a transaction state machine for a first user node, the state machine tracking a completion percentage of a primary data profile. The system 10 restricts processor access to certain functions until a specific data density is reached. The system will dynamically populate the primary data profile by executing an asynchronous data-fetch from a plurality of linked network sources. The present invention profiles a user as a giver or first user node using a state machine for a base level of data and uses asynchronous data fetching to fill in the first user node. Now, the profile completion is tracked and filled, but such harvesting of data creates questions of reliability and accuracy.

The system further extracts a hardware-rooted identifier from a data packet associated with the first user node. The hardware-rooted identifier can be IP addresses, secure enclave keys, Universally Unique Identifiers (UUID)s, and Media Access Control (MAC) addresses. The data packet can be a unit of data that corresponds to the primary data profile for the first user node. The present invention now takes this specific data, the hardware-rooted identifier, while the asset is the digital token or gift as a gift value or proxy for a physical product. Additionally, the system generates a device-specific target rating by processing the hardware-rooted identifier through a heuristic filter, the filter correlating the identifier with a contextual preference library, and outputs a restricted selection menu to the first user node, wherein the menu options are algorithmically limited based on the device-specific target rating. By processing hardware-rooted identifiers through a heuristic filter mapped to a contextual preference library, the system algorithmically constrains the available interaction space (the “restricted selection menu”). This technical constraint reduces the attack surface for unauthorized asset requests and ensures that asset re-routing is tethered to verified hardware signatures rather than spoofable software-layer credentials.

The system then receives a cryptographic signal representing a selected asset and a designated recipient node, and re-routes the selected asset to a second transaction state machine associated with the designated recipient node as the second user node. The re-routing is conditioned upon a verification of a second hardware-rooted identifier associated with the second user node.

Embodiments of the present invention include the hardware-rooted identifier being an Internet Protocol (IP) address. The contextual preference library can be a geolocation-dependent database, and the heuristic filter is configured to assign a dynamic weighting to the hardware-rooted identifier based on a detected network latency. The device-specific target rating is adjusted in real-time as the detected network latency crosses a predefined threshold. The heuristic filter validates the hardware-rooted identifier by comparing it against a distributed ledger of verified device signatures stored across the plurality of distributed nodes. The transaction profile, target profile, and target sub-profiles are defined by respective hardware-rooted identifiers.

Other embodiments include the system generating the device-specific target rating by calculating a probabilistic confidence score that the hardware-rooted identifier originates from a trusted hardware environment. Then, the restricted selection menu is filtered to exclude assets exceeding a risk value associated with the confidence score. The asset as a gift can only be processed with sufficient hardware-rooted identification. The contextual preference library can be a mapping of hardware-rooted identifiers to historical transaction patterns, and the heuristic filter correlates the current data packet with said historical patterns to predict a user intent.

The foregoing disclosure and description of the invention is illustrative and explanatory thereof. Various changes in the details of the illustrated structures, construction and method can be made without departing from the true spirit of the invention.

I claim:

1. A system for secure network-based asset redistribution using verified device signatures, the system comprising:
a network interface configured to communicate with a plurality of distributed nodes;
a hardware processor in communication with the network interface; and
a non-transitory memory storing a multidimensional data structure, the memory storing instructions that, when executed by the hardware processor, cause the system to:
instantiate a transaction state machine for a first user node, the state machine tracking a completion percentage of a primary data profile;
dynamically populate the primary data profile by executing an asynchronous data-fetch from a plurality of linked network sources;
extract a hardware-rooted identifier from a data packet associated with the first user node;
generate a device-specific target rating by processing the hardware-rooted identifier through a heuristic filter, the filter correlating the identifier with a contextual preference library;
output a restricted selection menu to the first user node, wherein the menu options are algorithmically limited based on the device-specific target rating;
receive a cryptographic signal representing a selected asset and a designated recipient node; and
re-route the selected asset to a second transaction state machine associated with the designated recipient node, wherein the re-routing is conditioned upon a verification of a second hardware-rooted identifier associated with the second user node.

2. The system of claim 1, wherein the hardware-rooted identifier comprises an Internet Protocol (IP) address.

3. The system of claim 1, wherein the contextual preference library comprises a geolocation-dependent database.

4. The system of claim 1, wherein the heuristic filter is configured to assign a dynamic weighting to the hardware-rooted identifier based on a detected network latency, wherein the device-specific target rating is adjusted in real-time as the detected network latency crosses a predefined threshold.

5. The system of claim 1, wherein the heuristic filter validates the hardware-rooted identifier by comparing it against a distributed ledger of verified device signatures stored across the plurality of distributed nodes.

6. The system of claim 1, wherein generating the device-specific target rating comprises calculating a probabilistic confidence score that the hardware-rooted identifier originates from a trusted hardware environment, and wherein the restricted selection menu is filtered to exclude assets exceeding a risk value associated with the confidence score.

7. The system of claim 1, wherein the contextual preference library comprises a mapping of hardware-rooted identifiers to historical transaction patterns, and the heuristic filter correlates the current data packet with said historical patterns to predict a user intent.
